(19) United States
(12) Patent Application Publication
(10) Pub. No.: US 2014/0333890 A1
(43) Pub. Date: Nov. 13, 2014

(54) ELECTRICAL CONNECTION STRUCTURE BETWEEN SPECTACLES LEGS AND LENSES OF ELECTRONIC GLASSES

(71) Applicant: Xiang Xia, Shanghai (CN)

(72) Inventor: Xiang Xia, Shanghai (CN)

(21) Appl. No.: 14/275,911

(22) Filed: May 13, 2014

(30) Foreign Application Priority Data
May 13, 2013 (CN) 201320259261.6

(51) Int. Cl. G02C 11/00

(52) U.S. Cl. CPC G02C 11/10
USPC 351/158

(57) ABSTRACT

The invention discloses an electrical connection structure between spectacles legs and lenses of electronic glasses, comprising spectacles legs, connecting components arranged on the lenses for connecting the spectacles legs, and electrical connecting components for realizing electrical connection between the spectacles legs and the connecting components, wherein said lenses are connected to said connecting components, and a groove for the electrical connecting component to pass through is arranged on a contact portion where the spectacles leg connects to the connecting component. The hinge structure provided by the invention is easy to be dismounted and convenient to be maintained, particularly, the grooves for the electrical connecting components to pass through are arranged in or outside the hinge structure, namely, it's convenient for the electrical connecting components to be connected to the spectacles legs from the spectacles frame, and meanwhile, the hinge structure is used for protecting the electrical connecting components.

### CROSS REFERENCE TO RELATED APPLICATION

The application claims priority of Chinese Utility Model Application No. 201320259261.6 filed on May 13, 2013, the entire content of which is hereby incorporated by reference.

### FIELD OF THE INVENTION

The present invention relates to one kind of glasses, and more particularly to an electrical connection structure between spectacles legs and lenses of electronic glasses, wherein the connection structures between the spectacles frame and spectacles legs or spectacles legs and lenses can be easily disassembled, and when folding the glasses between the spectacles frame and spectacles legs or spectacles legs and lenses, some controlling wires or grooves for electrical charge flow or circuit conduction will not be exposed.

### BACKGROUND OF THE INVENTION

There are many types of glasses, such as optical glasses, sunglasses, goggles, ski goggles, diving glasses. People not only need the professional performance of the glasses in the daily life, but also need other functions like recording what one sees and hears at any time, accurately positioning, obtaining various video and image information in time, setting up wireless communication with others whenever and wherever possible, connecting through wireless broadband internet and so on.

In addition, people often need to take high quality images, capture high-definition videos of the important scenes and main positions from different angles wherever they are on the ground, in the sky or under the water of the complex locations of the city, suburb and mountain; and then send the images, videos, audio signals to the receiving locations through the wireless transmission or to the command center through other routes; finally, distribute and process images, videos, audio signals, which is suitable for observation and monitoring in the field of public safety and military fields.

The patent application of which the application number is 201010137875.8 gives detailed description of a kind of glasses which meets the above-mentioned requirements. But this kind of glasses have relatively complete functions, which involves much more electronic circuits, so inevitably there will be some faults need to maintain, and the whole glasses have to be sent to maintain so that all parts of the glasses are useless during the maintaining time. Meanwhile, some controlling wires between the spectacles frame and spectacles legs will be easily exposed when the glasses mentioned in the above identified application is folded between the spectacles frame and spectacles legs. As a result, it will affect the appearance of the glasses, more seriously, the exposed wires will be easily damaged and the entire service life of glasses will be shortened.

### SUMMARY OF THE INVENTION

The technical problem which the present invention is about to solve is to provide an electrical connection structure between spectacles legs and lenses of electronic glasses according to the need for the structure of the electronic glasses.

The technical problem of this present invention can be solved by the following technical solutions:

An electrical connection structure between spectacles legs and lenses of electronic glasses, including spectacles legs, connecting components arranged on the lenses for connecting the spectacles legs, and electrical connecting components for realizing electrical connection between the spectacles legs and the connecting components, wherein the lenses are connected to said connecting components, and a groove for the electrical connecting component to pass through is arranged on a contact portion where the spectacles leg connects to the connecting component.

In a preferable embodiment, a detachable hinge structure for hinge jointing the spectacles legs and the connecting components is arranged on the contact portion between the spectacles leg and the connecting component, and the groove is arranged in the detachable hinge structure.

In a preferable embodiment, a detachable hinge structure for hinge jointing the spectacles legs and the connecting components is arranged on the contact portion between the spectacles leg and the connecting component; said groove is arranged outside said detachable hinge structure.

In a preferable embodiment, an execution component is arranged on said spectacles legs or said connecting components or lenses.

In a preferable embodiment, the execution component is selected from any one or any combination of two or more of a camera, a lighting device, a laser device, a projection device, an infrared producing device, an infrared transmitting device, an infrared acquisition device, an acoustic wave producing device, an acoustic wave transmitting device, an acoustic wave acquisition device, an electromagnetic wave producing device, an electromagnetic wave transmitting device, an electromagnetic wave acquisition device, an odor emitting device, a skin permeability material release device, an acupuncture point magnetic massage device, and a shooting device.

In a preferable embodiment, said connecting component is a spectacles frame.

In a preferable embodiment, said connecting component is lenses themselves.

In a preferable embodiment, said connecting component is a main and sub spectacles frame, lenses are fixed on the sub spectacles frame, the main spectacles frame is connected to the spectacles legs, said main and sub frame are assembled by screw or buckle or other methods.

In a preferable embodiment, said electrical connecting component is wires or fibers, said groove is used for protecting the wires or fibers.

In a preferable embodiment, said electrical connecting component comprises a first electrical conduction structure attached to outside or inside of said spectacles legs, and a second electrical conduction structure attached to outside or inside of said connecting component, an electrical connection is formed between the first electrical conduction structure and the second electrical conduction structure; said electrical connection is arranged in said groove.

In a preferable embodiment, the lenses are electrically connected with said connecting component.

In a preferable embodiment, said electrical connection is carried out by a socket or a switch or by both.

As a result of the above technical solutions, the hinge structure provided by the invention is easy to be dismounted and convenient to be maintained, particularly, the grooves for the electrical connecting components to pass through are arranged in or outside the hinge structure, namely, it's convenient for the electrical connecting components to be connected to the spectacles legs from the spectacles frame, and meanwhile, the hinge structure is used for protecting the electrical connecting components.

### BRIEF DESCRIPTION OF THE DRAWINGS

FIG. 1 is a schematic view of electronic glasses in embodiment 1 according to the present invention;

FIG. 2 is a schematic view of the detachable hinge structure in embodiment 1 according to the present invention; and

FIG. 3 is a schematic view of the structure of the detachable hinge structure in embodiment 2 according to the present invention.

### DETAILED DESCRIPTION OF ILLUSTRATED EMBODIMENTS

Now combine the following embodiments and the accompanying drawings to further describe the present invention.

The present invention discloses an electrical connection structure between spectacles legs and lenses of electronic glasses, comprising spectacles legs, connecting components arranged on the lenses for connecting the spectacles legs, and electrical connecting components for realizing electrical connection between the spectacles legs and the connecting components, wherein the lenses are connected to the connecting components, and a groove for the electrical connecting component to pass through is arranged on a contact portion where the spectacles leg connects to the connecting component.

Particularly, a detachable hinge structure for hinge jointing the spectacles legs and the connecting components is also arranged on the contact portion between the spectacles legs and the connecting components, and the groove for the electrical connecting component to pass through is arranged in, above, under, outside, inside the detachable hinge structure, thus the detachable hinge structure can be used to protect the groove.

Further, an execution component can be arranged on said spectacles legs or said connecting components or lenses. And the execution component is selected from any one or any combination of two of a camera, a lighting device, a laser device, a projection device, an infrared producing device, an infrared transmitting device, an infrared acquisition device, an acoustic wave producing device, an acoustic wave transmitting device, an acoustic wave acquisition device, an electromagnetic wave producing device, an electromagnetic wave transmitting device, an electromagnetic wave acquisition device, an odor emitting device, a skin permeability material release device, an acupuncture point magnetic massage device, and a shooting device.

The connecting component could be a spectacles frame, of course, not limited to the spectacles frame. With regard to the electronic frameless glasses, the connecting components can be directly arranged on the lenses, or it can be integrated with the lenses, that is to say, the components can be lenses themselves. Or the connecting component is a main and sub spectacles frame, lenses are fixed on the sub spectacles frame, the main spectacles frame is connected to the spectacles legs, said main and sub frame are assembled by screw or buckle or by both.

Thus, in case that the connecting component is the spectacles frame, the main parts of the electronic glasses are spectacles legs, frames and lenses.

In case that the connecting component is not the spectacles frame, the main parts of the electronic glasses can be spectacles legs and lenses.

The lenses can be one-piece lenses or combined lenses, and the electrical connecting component can be arranged on the one-piece lenses, or arranged on one part of the combined lenses and combined with the other part as complete lenses to electrically connect the spectacles legs and lenses.

The electrical connecting component can be wires or fibers, the groove is used to protect the wires or fibers, which can be arranged in, above, under, outside or inside the detachable hinge structure, thus the detachable hinge structure can be used to protect the wires or fibers.

Besides, the electrical connecting component can includes a first electrical conduction structure attached to the spectacles legs, such as the wires embedded within the spectacles legs or the conductive bars attached to the surface of the spectacles legs, and the second electrical conduction structure attached to outside or inside of the connecting components, which can also be the wires embedded within the connecting components or the conductive bars attached to the surface of the connecting components. An electrical connection is formed between the first electrical conduction structure and the second electrical conduction structure, which is located in, above, under, outside or inside the detachable hinge structure, thus the detachable hinge structure can be used to protect the electrical connection. And the electrical connection is carried out by a socket, a switch, or both of socket or switch.

The method of using a socket to carry out the electrical connection is achieved by plugging the electrical connecting component. And the electrical connection within the groove can be carried out by a socket or other electrical connecting components.

Besides, the electrical connection can be carried out by a key switch or other forms of switches, such as voice switches, pressure switches, temperature switches, gravity switches, electromagnetic switches, human tissues, organs motion sensor switches or human biological electric switches, etc, which achieves the conduction or turnoff of electronic performance of the electrical connection.

Furthermore, the lenses are electrically connected to the connecting component, and the electrical connecting component can be directly integrated with the lenses or the spectacles frame by being inserted into the lenses or connected to the spectacles frame to realize electronic lenses functions such as digital display, electronic regulation of the transmittance, electronic reflectance, harmful rays elimination and other electronic functions.

Moreover, the execution component can be arranged on the lenses or be integrated with the lenses to make the lenses electrically connected to the spectacles legs via the connecting component or make the lens directly electrically connected to the spectacles legs so as to realize every function of electronic glasses.

Two following embodiments will be given to further explain the present invention. Apparently, the embodiments described thereinafter merely a part of embodiments of the present invention, but not all embodiments. Persons skilled in the art can obtain all other embodiments without creative works, based on these embodiments, which pertains to the protection scope of the present invention.

### Embodiment 1

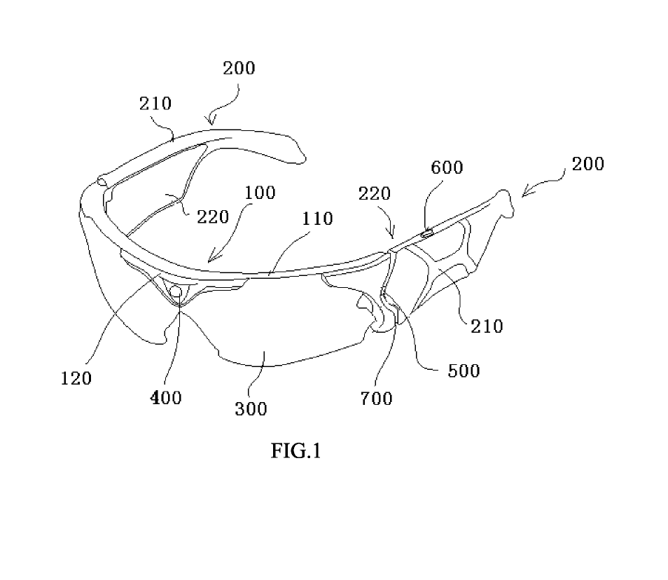

Referring to FIG. 1, the electronic glasses include a spectacles frame 100 and a pair of spectacles legs 200.

The spectacles frame 100 includes an inner housing of spectacles frame 110 and an outer housing of spectacles frame 120, and both of which could be mounted together with fasteners or other fastening methods. The lens 300 can be arranged between the inner housing of the spectacles frame 110 and the outer housing of the spectacles frame 120, on the lens 300 a through electronic display is arranged, thus people can surf the Internet and watch videos via the through electronic display. The execution component 400 is arranged above the nose pad in the middle of the spectacles frame 100, and the execution component 400 can be selected from any one or any combination of two or more of a camera, a lighting device, a laser device, a projection device, an infrared producing device, an infrared transmitting device, an infrared acquisition device, an acoustic wave producing device, an acoustic wave transmitting device, an acoustic wave acquisition device, an electromagnetic wave producing device, an electromagnetic wave transmitting device, an electromagnetic wave acquisition device, an odor emitting device, a skin permeability material release device, an acupuncture point magnetic massage device, and a shooting device.

The spectacles leg 200 includes the inner housing of the spectacles leg 210 and the outer housing of the spectacles leg 220, and both of them are assembled together via fasteners, or buckles, spiral, or other fastening methods. Power supply and some electronic essential control modules could be installed between the spectacles leg 210 and the outer housing of the spectacles leg 220, the control module and execution component 400 together with the electronic display are connected with data wire 500, or the data wire 500 is directly consolidated or integrated with the spectacles legs, spectacles frame or the electronic display as a whole. These data wires or the data conduction materials integrated with the spectacles frame 100 or spectacles legs serves the function of data connectivity and charge mobile or moving, and they can pass through the hinged place of the spectacles frame 100 and a pair of spectacles legs 200 according to the needs. Furthermore, a control switch 600 is arranged on the outer housing of the spectacles leg 220. For example, the switch mode of the electrical connection can be realized by controlling the switch 600. Press the switch 600, the electronic performance of electrical connection is turned on, and then press the switch 600, the electronic performance of electrical connection is turned off. The inside of the groove can be a physical connection to achieve electrical connection by the socket mode.

In order to facilitate maintenance, the hinge between the spectacles frame 100 and a pair of hinges 200 could be a detachable hinge 700, once detaching the detachable hinge 700, the spectacles frame 100 and spectacles legs 200 can be separately maintained.

Furthermore, the spectacles frame 100 could be a main and sub spectacles frame, lenses are fixed on the sub spectacles frame, the main spectacles frame is connected to the spectacles legs, said main and sub frame are connected by screws or buckles or other methods.

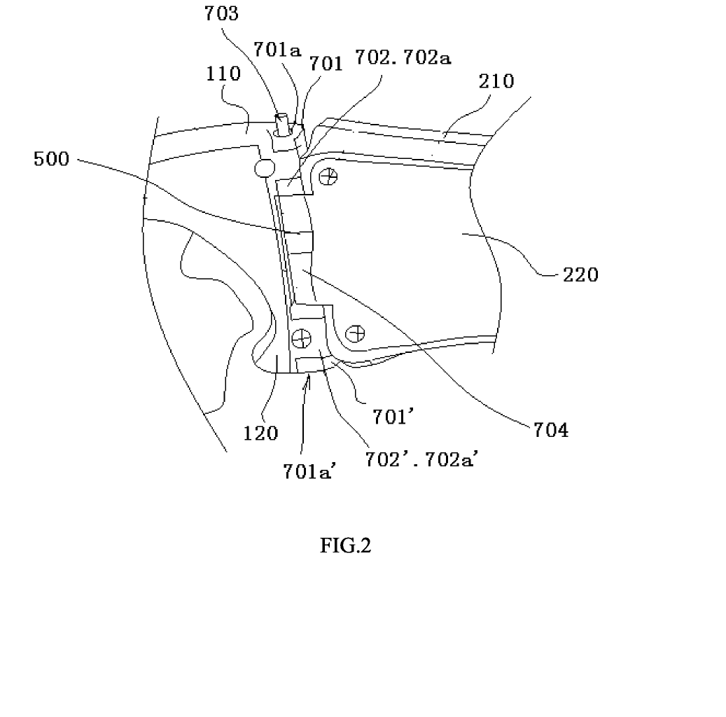

Referring to FIG. 2, the detachable hinge mechanism 700 of this embodiment includes a pair of hinge portions 701, 701 arranged on the outer housing of the spectacles frame 120 and a pair of hinge portions 702 and 702′ arranged on the outer housing of the spectacles legs 220. Coaxial axle holes 701a and 701a′ are respectively arranged on a pair of hinge portions 701 and 701′, and coaxial axle holes 702a and 702a′ are respectively arranged on a pair of hinge portions 702 and 702′. The hinge portions 702 and 702′ are located between the hinge portions 701 and 701′ and respectively corresponding to the hinge portions 701 and 701′. The axle holes 701a and 701a′ are connected with the corresponding axle holes 702a and 702a′ by screws 703 (also, could via the shaft or buckle). And a groove 704 is provided between the hinge portions 702 and 702′, of which the two ends are respectively extending into the frame, the place between the outer housing 110, 120, and the legs, the place between the outer housing 210 and 220. The data or circuit wires 500 pass through the groove 704, therefore, the data or circuit wires 500 will not be exposed and damaged due to the protection of hinge portions. In other case, data or circuit wires 500 could be inserted into the spectacles legs or frame and directly integrated with the legs or frame as a whole, meanwhile, pass through the hinge portion and groove 704, thus it can be protected from exposing and damaging.

### Embodiment 2

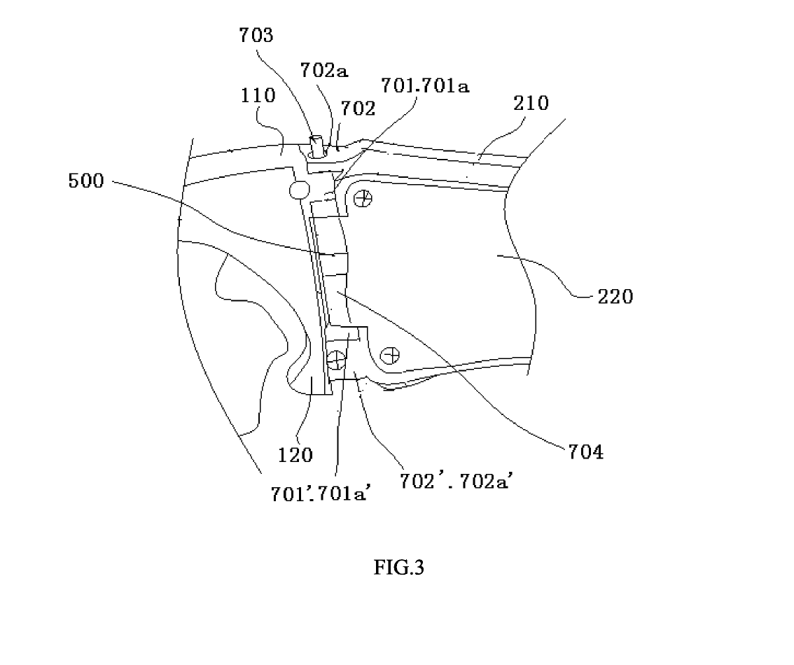

Referring to FIG. 3, the detachable hinge mechanism 700 of this embodiment includes a pair of hinge portions 701 and 701′ arranged on the outer housing of the spectacles frame 120 and a pair of hinge portions 702 and 702′ arranged on the outer housing of the spectacles legs 220. Coaxial axle holes 701a and 701a′ are respectively arranged on a pair of hinge portions 701 and 701′, and coaxial axle holes 702a and 702a′ are respectively arranged on a pair of hinge portions 702 and 702′. The hinge portions 701 and 701′ are located between the hinge portions 702 and 702′ and respectively corresponding to the hinge portions 701 and 701′. The axle holes 701a and 701a′ are connected with the corresponding axle holes 702a and 702a′ by screws 703 (also, can be connected with each other by the shaft). And a groove 704 is provided between the hinge portions 701 and 701′, of which the two ends are respectively extending into the frame, the place between the outer housing 110, 120, and the legs, the place between the outer housing 210 and 220. The data wires 500 pass through the groove 704, thus data wires 500 will not be exposed and damaged due to the protection of hinge portions. Or data or circuit wires 500 are inserted into the legs or frame and directly integrated with the legs or frame as a whole, meanwhile, pass through the hinge portion and groove 704, thus it can be protected from exposing and damaging.

What is claimed is:

1. An electrical connection structure between spectacles legs and lenses of electronic glasses, comprising spectacles legs, connecting components arranged on the lenses for connecting the spectacles legs, and electrical connecting components for realizing electrical connection between the spectacles legs and the connecting components, wherein said lenses are connected to said connecting components, and a groove for the electrical connecting component to pass through is arranged on a contact portion where the spectacles leg connects to the connecting component.

2. The electrical connection structure between spectacles legs and lenses of electronic glasses according to claim 1, characterized in that a detachable hinge structure for hinge jointing the spectacles legs and the connecting components is arranged on the contact portion between the spectacles leg and the connecting component, and the groove is arranged in said detachable hinge structure.

3. The electrical connection structure between spectacles legs and lenses of electronic glasses according to claim 1, characterized in that a detachable hinge structure for hinge jointing the spectacles legs and the connecting components is arranged on the contact portion between the spectacles leg and the connecting component, said groove is arranged outside said detachable hinge structure.

4. The electrical connection structure between spectacles legs and lenses of electronic glasses according to claim 1, characterized in that an execution component is arranged on said spectacles legs or said connecting components.

5. The electrical connection structure between spectacles legs and lenses of electronic glasses according to claim 4, characterized in that the execution component is selected from any one or any combination of two of a camera, a lighting device, a laser device, a projection device, an infrared producing device, an infrared transmitting device, an infrared acquisition device, an acoustic wave producing device, an acoustic wave transmitting device, an acoustic wave acquisition device, an electromagnetic wave producing device, an electromagnetic wave transmitting device, an electromagnetic wave acquisition device, an odor emitting device, a skin permeability material release device, an acupuncture point magnetic massage device, and a shooting device.

6. The electrical connection structure between spectacles legs and lenses of electronic glasses according to claim 1, characterized in that said connecting component is a spectacles frame or lenses.

7. The electrical connection structure between spectacles legs and lenses of electronic glasses according to claim 1, characterized in that said connecting component is a main and sub spectacles frame, lenses are fixed on the sub spectacles frame, the main spectacles frame is connected to the spectacles legs, said main and sub frame are assembled by screw or buckle.

8. The electrical connection structure between spectacles legs and lenses of electronic glasses according to claim 1, characterized in that said electrical connecting component is wires or fibers, and said groove is used for protecting the wires or fibers.

9. The electrical connection structure between spectacles legs and lenses of electronic glasses according to claim 1, characterized in that said electrical connecting components comprise a first electrical conduction structure attached to outside or inside of said spectacles legs, and a second electrical conduction structure attached to outside or inside of said connecting components, an electrical connection is formed between the first electrical conduction structure and the second electrical conduction structure; said electrical connection is arranged in said groove.

10. The electrical connection structure between spectacles legs and lenses of electronic glasses according to claim 1, characterized in that the lenses are electrically connected with said connecting components.

11. The electrical connection structure between spectacles legs and lenses of electronic glasses according to claim 1, characterized in that said electrical connection is carried out by a socket or a switch or by both.
